(19) United States
(12) Patent Application Publication
(10) Pub. No.: US 2002/0094259 A1
(43) Pub. Date: Jul. 18, 2002

(54) Dumping system for pick-up trucks

(76) Inventor: Lloyd Michael Wallace, Los Angeles, CA (US)

Correspondence Address: Richard W. Goldstein, 2071 Clove Road, Staten Island, NY, 10304, US

(21) Appl. No.: 09/759,310

(22) Filed: Jan. 16, 2001

(51) Int. Cl. B65G 67/00

(52) U.S. Cl. 414/402; 414/337

(57) ABSTRACT

A dumping system for pick-up trucks including a slidable member disposed within the bed of the pick-up truck. The slidable member generally includes a sliding vertical dump board positioned essentially perpendicular with respect to the truck bed. The vertical dump board is positioned along the inner edge of the bed in a starting orientation and along the outer edge of the bed in an ending orientation. A stabilizing mechanism is fixed to the ground surface and couplable with the slidable member whereby forward movement of the pick-up truck will allow the slidable member to force the debris out through the tailgate in an open orientation. The stabilizing member may comprise of an inverted L-shaped arm member engagable with the sliding vertical plate and a base member fixed to the ground. Alternatively, the stabilizing member may be a cable fixed to the base member. Accordingly, said cable is couplable with the sliding member and then extending rearwardly along the bed to the base member, so that when the truck is driven forward, the stabilizing member remains stationary and debris on said bed rearward of the sliding member is swept from the bed.

### BACKGROUND OF THE INVENTION

The present invention relates to a dumping system for pick-up trucks and more particularly pertains to allowing debris positioned within a bed of a pick-up truck to be easily removed.

The use of a pick-up truck is typical in any home repair or similar type of industry where a significant amount of debris is accumulated. This debris needs to be disposed of properly in a sanitation field or the like. This disposal is usually an arduous task involving multiple individuals who either manually throw large pieces of debris out of the truck or sweep small debris out of the bed once the tailgate has been lowered. This process is often time consuming and tiresome—making the return to a productive work day less likely. What is needed is a way to remove debris from the bed of a pick-up truck in a manner that is neither time-consuming or tiresome.

The present invention attempts to solve the abovementioned problem by providing a device that will allow debris disposed within a bed of a pick-up truck to be removed therefrom with very little effort.

The use of sweeping devices is known in the prior art. More specifically, sweeping devices heretofore devised and utilized for the purpose of sweeping debris for disposal are known to consist basically of familiar, expected and obvious structural configurations, notwithstanding the myriad of designs encompassed by the crowded prior art which have been developed for the fulfillment of countless objectives and requirements.

While these devices fulfill their respective, particular objective and requirements, these patents do not describe a dumping system for pick-up trucks for allowing debris positioned within a bed of a pick-up truck to be easily removed.

In this respect, the dumping system for pick-up trucks according to the present invention substantially departs from the conventional concepts and designs of the prior art, and in doing so provides an apparatus primarily developed for the purpose of allowing debris positioned within a bed of a pick-up truck to be easily removed.

Therefore, it can be appreciated that there exists a continuing need for new and improved dumping system for pick-up trucks which can be used for allowing debris positioned within a bed of a pick-up truck to be easily removed. In this regard, the present invention substantially fulfills this need.

### SUMMARY OF THE INVENTION

In the view of the foregoing disadvantages inherent in the known types of sweeping devices now present in the prior art, the present invention provides an improved dumping system for pick-up trucks. As such, the general purpose of the present invention, which will be described subsequently in greater detail, is to provide a new and improved dumping system for pick-up trucks which has all the advantages of the prior art and none of the disadvantages.

To attain this, the present invention essentially comprises a slidable member disposed within the bed of the pick-up truck. The slidable member generally includes a sliding vertical dump board positioned essentially perpendicular with respect to the truck bed. The vertical dump board is positioned along the inner edge of the bed in a starting orientation and along the outer edge of the bed in an ending orientation. A stabilizing mechanism is fixed to the ground surface and couplable with the slidable member whereby forward movement of the pick-up truck will allow the slidable member to force the debris out through the tailgate in an open orientation. The stabilizing member may comprise of an inverted L-shaped arm member engagable with the sliding vertical plate and a base member fixed to the ground. Alternatively, the stabilizing member may be a cable fixed to the base member. Accordingly, said cable is couplable with the sliding member and then extending rearwardly along the bed to the base member, so that when the truck is driven forward, the stabilizing member remains stationary and debris on said bed rearward of the sliding member is swept from the bed.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved dumping system for pick-up trucks which has all the advantages of the prior art sweeping devices and none of the disadvantages.

It is another object of the present invention to provide a new and improved dumping system for pick-up trucks which may be easily and efficiently manufactured and marketed.

It is a further object of the present invention to provide a new and improved dumping system for pick-up trucks which is of durable and reliable construction.

An even further object of the present invention is to provide a new and improved dumping system for pick-up trucks which is susceptible of a low cost of manufacture with regard to both materials and labor, and which accordingly is then susceptible of low prices of sale to the consuming public, thereby making such a dumping system for pick-up trucks economically available to the buying public.

Even still another object of the present invention is to provide a new and improved dumping system for pick-up trucks for allowing debris positioned within a bed of a pick-up truck to be easily removed.

Lastly, it is an object of the present invention to provide a new and improved dumping system for pick-up trucks including a slidable member disposed within the bed of the pick-up truck. The slidable member generally includes a sliding vertical dump board positioned essentially perpendicular with respect to the truck bed. The vertical dump board is positioned along the inner edge of the bed in a starting orientation and along the outer edge of the bed in an ending orientation. A stabilizing mechanism is fixed to the ground surface and couplable with the slidable member whereby forward movement of the pick-up truck will allow the slidable member to force the debris out through the tailgate in an open orientation. The stabilizing member may comprise of an inverted L-shaped arm member engagable with the sliding vertical plate and a base member fixed to the ground. Alternatively, the stabilizing member may be a cable fixed to the base member. Accordingly, said cable is couplable with the sliding member and then extending rearwardly along the bed to the base member, so that when the truck is driven forward, the stabilizing member remains stationary and debris on said bed rearward of the sliding member is swept from the bed.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the dumping system for pick-up trucks constructed in accordance with the principles of the present invention.

FIG. 2 is a perspective view of the present invention illustrated in use.

FIG. 3 is a perspective view of an alternate embodiment of the present invention.

FIG. 4 is a perspective of the alternate embodiment illustrated in use.

The same reference numerals refer to the same parts through the various figures.

### DESCRIPTION OF THE PREFERRED EMBODIMENT

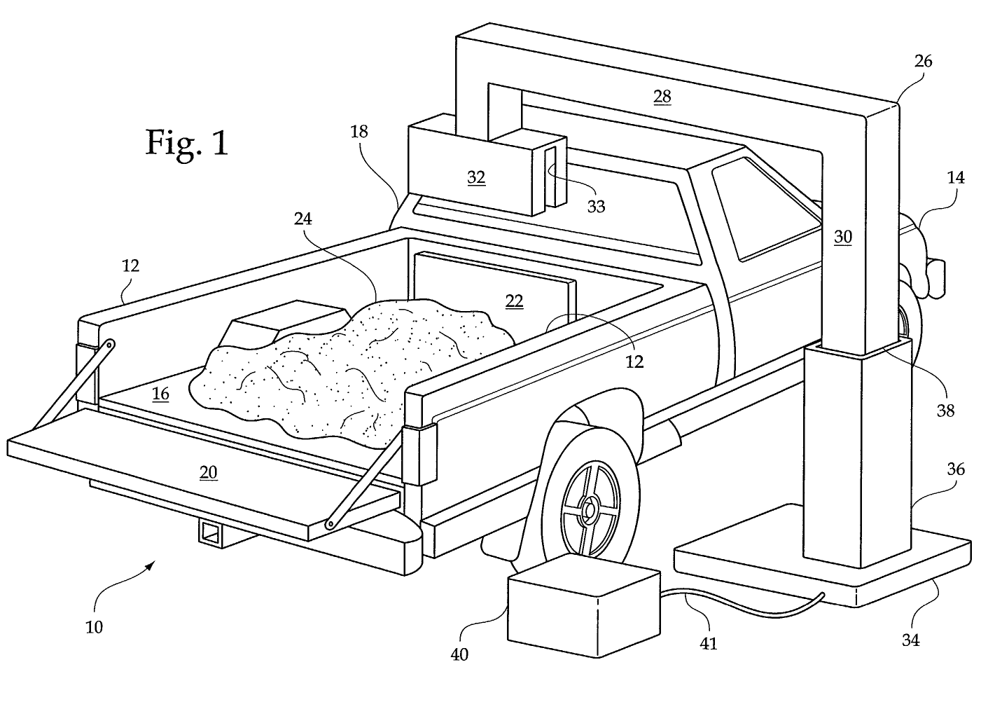

With reference now to the drawings, and in particular, to FIGS. 1 through 4 thereof, the preferred embodiment of the new and improved dumping system for pick-up trucks embodying the principles and concepts of the present invention and generally designated by the reference number 10 will be described.

Specifically, it will be noted in the various figures that the device relates to a dumping system for pick-up trucks for allowing debris positioned within a bed of a pick-up truck to be easily removed. In its broadest context, the device consists of a slidable member and a stabilizing mechanism. Such components are individually configured and correlated with respect to each other so as to attain the desired objective.

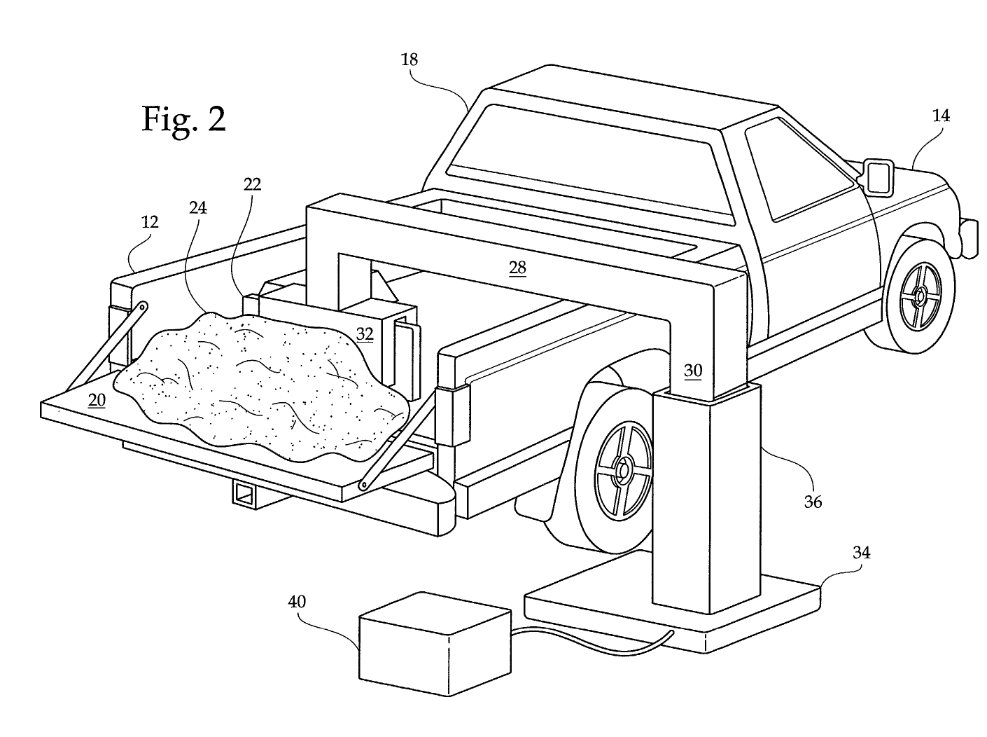

For use with the present invention, a pickup truck 14 includes a bed 16 having bed sides 12, and a bed width defined between the bed sides 12. The bed includes an inner edge and an outer edge. The inner edge is located adjacent to the cab 18 of the pick-up truck 14. The outer edge is located adjacent to the tailgate 20 of the pick-up truck 14. A slidable member is located upon the bed 16, between the bed sides 12. The slidable member includes a sliding vertical dump board 22 positioned essentially perpendicular with respect to the horizontal plate 16, and extending substantially the bed width, minus obstructions located between the bed sides 15 such as wheelwells, tie-down hardware, and the like. The dump board 22 is positioned along the inner edge of the bed 16 in a starting orientation, note FIG. 1, and along the outer edge of the bed 16 in an ending orientation, note FIG. 2. The dump board 22 acts to sweep debris 24 out through the open tailgate 20.

The stabilizing mechanism is couplable with the slidable member whereby forward movement of the pick-up truck 14 will allow the slidable member to force the debris 24 out through the tailgate 20 in an open orientation. Note FIG. 2. In the embodiment of FIG. 1 and FIG. 2, the stabilizing member is comprised of an inverted U-shaped arm member 26 engagable with the sliding vertical plate 22. The arm member 26 has an upper horizontal extent 28 and a lower vertical extent 30. The upper horizontal extent 28 has an inverted U-shaped bracket 32 extending downwardly therefrom. The bracket 32 has a slot 33 which selectively receives the vertical dump board 22 therein. The stabilizing member includes a base member defined by a planar lower plate 34 which is anchored to the ground therebeneath and an upper receiving sleeve 36. The upper receiving sleeve 36 has an open upper end 38 for receiving the lower vertical extent 30 of the arm 26 therein. The stabilizing member includes a lifting motor 40. The lifting motor 40 is preferably a hydraulic pump, which supplies pressurized hydraulic fluid through a hydraulic line 41 to selectively raise and lower the arm 26 with respect to the upper receiving sleeve 36 of the base member to selectively engage and disengage the dump board 22 with the slidable member. In use, the stabilizing member is be positioned within a dumping area. The user positions the pick-up truck 14 next to the stabilizing member with the sliding vertical plate 22 aligned with the bracket 32. The user then activates the motor 40 whereupon the bracket is lowered to engage the sliding vertical dump board 22. Once engaged, the pick-up truck 14 is slowly driven forward thereby allowing the sliding dump board 22 to move rearwardly along the bed 12 to force the debris 24 through the open tailgate 20.

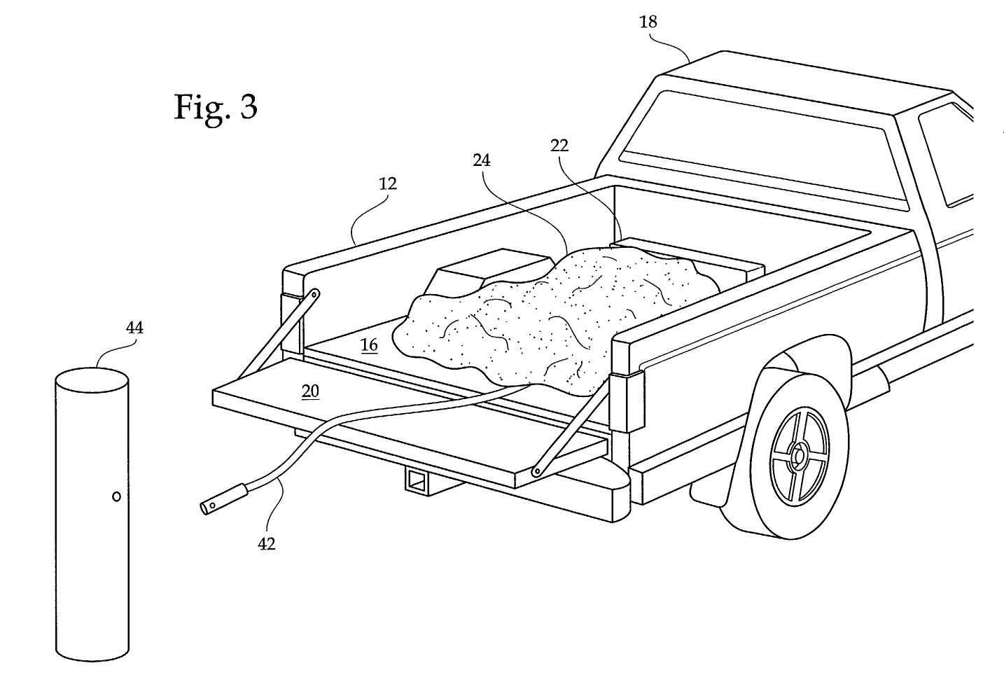

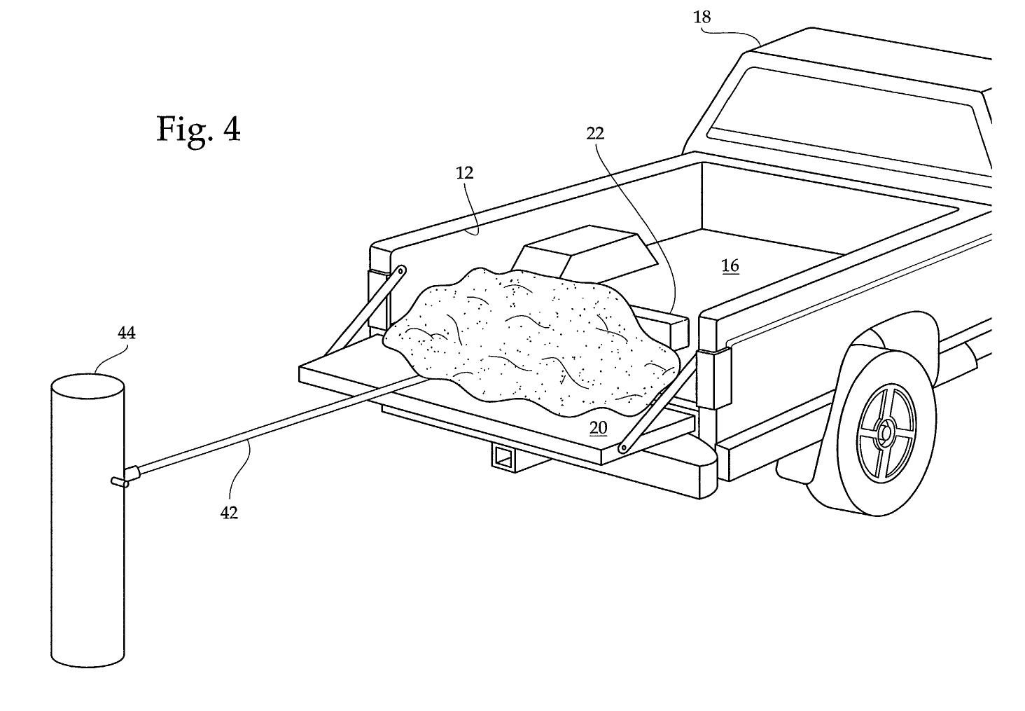

A second embodiment of the present invention is shown in FIGS. 3 and 4 and includes substantially all of the components of the present invention wherein the stabilizing member is comprised of a cable 42 having a first end and a second end and a cylindrical post secured to the ground surface. The first end is secured to the sliding vertical plate 22 of the slidable member. The cylindrical post 44 is engagable with the second end of the cable 42. In use, the dump board 22 is initially positioned near the cab 18, wherein the cable 42 is laid flat upon the bed 16 extending rearwardly toward the tailgate 20. The truck is filled with debris—piling debris 24 on top of the cable by making certain that the second end is still accessible near the tailgate and is not itself covered with debris. Once reaching the dump site, the dump board 22 the driver will back up the pick-up truck 14 to a location near the cylindrical post 44 whereupon the second end of the cable 42 is attached to the post 44 near its top. The driver then drives the pick-up truck 14 forwardly so the sliding vertical dump board 22 will move rearwardly along the bed 12 to force the debris 24 through the open tailgate 20.

It should be noted that according to the alternate embodiment, the dump board 22 is preferably a post of square cross section which extends substantially between the bed sides, as shown in FIG. 3 and 4, as opposed to a tall, vertical configuration as shown in FIG. 1 and 2, so that it will remain stable as it is pulled rearwardly when dumping. In particular, said post would preferably be approximately eight inch by eight inch post.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by letters patent of the united states is as follows:

1. A dumping system, for use with pick-up trucks having a bed, a cab, and a tailgate, the bed having bed sides, an inner edge near the cab, and an outer edge near the tailgate, for allowing debris positioned within the bed of a pick-up truck to be easily removed comprising, in combination:
a slidable member disposed within the bed of the pick-up truck, the slidable member including a sliding vertical dump board positionable essentially perpendicular with respect to the bed, in use the dump board being positioned along the inner edge of the bed in a starting orientation and along the outer edge of the bed in an ending orientation; and
a stabilizing mechanism couplable with the slidable member whereby forward movement of the pick-up truck will allow the slidable member to force the debris out through the tailgate in an open orientation, the stabilizing member being comprised of an inverted L-shaped arm member engagable with the dump board, the arm member having an upper horizontal extent and a lower vertical extent, the upper horizontal extent having an inverted U-shaped bracket extending downwardly therefrom, the bracket having a slot for receiving the dump board therein, the stabilizing member including a base member defined by a planar lower plate and an upper receiving sleeve, the upper receiving sleeve having an open upper end for receiving the lower vertical extent of the arm therein, the stabilizing member including a motor, the motor selectively raising and lowering the arm with respect to the upper receiving sleeve of the base member to selectively engage and disengage the sliding dump board of the slidable member.

2. A dumping system, for use with pick-up trucks having a bed, a cab, and a tailgate, the bed having bed sides, an inner edge near the cab, and an outer edge near the tailgate, for allowing debris positioned within the bed of a pick-up truck to be easily removed comprising, in combination:
a slidable member disposed within the bed of the pick-up truck, the slidable member including a dump board positionable essentially perpendicular with respect to the bed, in use the dump board being positioned along the inner edge of the bed in a starting orientation and along the outer edge of the bed in an ending orientation; and
a stabilizing mechanism secured to a ground surface and couplable with the slidable member whereby forward movement of the pick-up truck will allow the slidable member to force the debris out through the tailgate in an open orientation

3. The dumping system for pick-up trucks as set forth in claim 2, wherein the dump board has a tall vertical configuration and the stabilizing member is comprised of an inverted L-shaped arm member engagable with the dump board.

4. The dumping system for pick-up trucks as set forth in claim 3, wherein the arm member has an upper horizontal extent and a lower vertical extent, the upper horizontal extent having an inverted U-shaped bracket extending downwardly therefrom, the bracket receiving the sliding vertical plate therein.

5. The dumping system for pick-up trucks as set forth in claim 4, wherein the stabilizing member includes a base member defined by a planar lower plate and an upper receiving sleeve, the upper receiving sleeve having an open upper end for receiving the lower vertical extent of the arm therein and allowing telescoping movement of the lower vertical extent therein.

6. The dumping system for pick-up trucks as set forth in claim 5, wherein the stabilizing member includes a motor, the motor selectively raising and lowering the arm with respect to the upper receiving sleeve of the base member to selectively engage and disengage the sliding vertical plate of the slidable member.

7. The dumping system for pick-up trucks as set forth in claim 2, wherein the stabilizing member is comprised of a cable having a first end and a second end and a cylindrical post fixed to a ground surface, the first end of said cable is secured to the dump board of the slidable member, the cylindrical post being engageable with the second end of the cable.

8. The dumping system for pick-up trucks as set forth in claim 7, wherein the dump board is a post of square cross section, capable of extending substantially between the bed sides.
